(19) United States
(12) Patent Application Publication
(10) Pub. No.: US 2025/0214570 A1
(43) Pub. Date: Jul. 3, 2025

(54) VEHICLE'S SIDE VIEW MIRROR PROTECTION AGAINST DAMAGES

(71) Applicant: DISH Network Technologies India Private Limited, Bengaluru (IN)

(72) Inventors: Sendhil Kumar KB, Bangalore (IN); Anandaraj P, Bengaluru (IN); Sreevastav Anupuru, Kurnool (IN)

(21) Appl. No.: 18/619,717

(22) Filed: Mar. 28, 2024

(30) Foreign Application Priority Data
Dec. 29, 2023 (IN) 202341090014

(51) Int. Cl. B60W 30/09; B60R 1/076; B60W 10/18; B60W 10/20; B60W 50/14

(52) U.S. Cl. CPC B60W 30/09; B60R 1/076; B60W 10/18; B60W 10/20; B60W 50/14; B60W 2420/408; B60W 2420/54; B60W 2554/402; B60W 2554/80

(57) ABSTRACT

Techniques are described for automatically detecting and responding to imminent damage to and/or from a vehicle's side-view mirror. One or more mirror collision anticipation sensors (MCASs) are integrated with one or more side-view mirrors, or otherwise with a vehicle. The MCASs generate sensor signals based on detecting a proximate environment of the side-view mirrors. A response processor can receive the sensor signals from the MCASs and can compute a present likelihood of an imminent collision event based on monitoring the sensor signals. The response processor can generate a trigger signal responsive to detecting that the present likelihood exceeds a predetermined trigger threshold and can output the trigger signal to a motor controller. The motor controller can execute an automated mirror evasion maneuver responsive to the trigger signal, including electromechanically repositioning the side-view mirrors relative to the vehicle's main body to hopefully avoid the imminent collision event.

### CROSS REFERENCE TO RELATED APPLICATIONS

This application claims priority to Indian Provisional Patent Application No. 202341090014, filed on Dec. 29, 2023, in the Indian Intellectual Property Office, the disclosure of which is incorporated by reference in its entirety for all purposes.

### BACKGROUND OF THE INVENTION

Street-legal passenger vehicles typically include a rear-view mirror and one or two side-view mirrors. For decades, side-view mirrors have been considered critical components for vehicle safety, particularly in multi-lane driving contexts, where such mirrors contribute to minimizing blind-spots and providing drivers with enhanced visibility of their vehicles' surroundings. However, because the side-view mirrors protrude from the sides of the vehicle, the side-view mirrors commonly become damaged by accidental collisions with obstructions. For example, drivers often accidentally damage their side-view mirrors by colliding with structures in parking lots, tight parking spaces, narrow driveways, etc. Further, side-view mirrors are often damaged by other drivers (e.g., when another driver is parking in an adjacent parking spot or is passing too closely in an adjacent lane), by other objects (e.g., a shopping cart being pushed between two vehicles, a pebble flying up on a road, etc.), etc.

### BRIEF SUMMARY OF THE INVENTION

Systems and methods are described herein for automatically detecting and responding to imminent damage to and/or from a vehicle's side-view mirror. One or more mirror collision anticipation sensors (MCASs) are integrated with one or more side-view mirrors, or otherwise with a vehicle. The MCASs generate sensor signals based on detecting a proximate environment of the side-view mirrors. A response processor can receive the sensor signals from the MCASs and can compute a present likelihood of an imminent collision event based on monitoring the sensor signals. The response processor can generate a trigger signal responsive to detecting that the present likelihood exceeds a predetermined trigger threshold and can output the trigger signal to a motor controller. The motor controller can execute an automated mirror evasion maneuver responsive to the trigger signal, including electromechanically repositioning the side-view mirrors relative to the vehicle's main body to hopefully avoid the imminent collision event.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1 shows an illustrative parking environment including multiple potential collision hazards that could result in damage to a side-view mirror of a vehicle.

FIGS. 2A and 2B show block diagrams of illustrative mirror collision avoidance systems, according to various embodiments described herein.

FIG. 3 shows an example of a side-view mirror 300 for use with embodiments described herein.

FIG. 4 shows an example of a vehicle side view mirrors 120 and several mirror collision anticipation sensors.

FIG. 5 shows a flow diagram of a method for mirror collision avoidance in a vehicle.

### DETAILED DESCRIPTION OF THE INVENTION

In the 1950s and 1960s, there was a massive expansion across the United States of multi-lane roadways and vehicle traffic. This gave rise to new vehicle safety standards, such as the National Traffic and Motor Vehicle Safety Act of 1966, which required vehicles to meet at least a minimum level of “rear visibility.” While those early requirements did not tend to specify particular mirrors or mirror configurations, rear-view mirrors quickly began to become standard equipment on vehicles by the end of that decade. By the late 1980s, many vehicles were being sold with a rear-view mirror, a driver-side side-view mirror, and a passenger-side side-view mirror all pre-installed. Newer vehicle safety regulations, such as the Federal Motor Vehicle Safety Standards (FMVSS) set forth by the National Highway Traffic Safety Administration (NHTSA) in the United States, the United Nations Economic Commission for Europe (UNECE) R46 standard, and the like, outline certain specifications for mirrors and mirror configurations and installations to ensure at least a minimum rear visibility for the driver.

Presently, side-view mirrors are ubiquitous on cars and other roadway vehicles, and they tend to be considered as critical vehicle safety equipment. However, side-view mirrors typically protrude some distance from the sides of a vehicle (e.g., 20 to 30 centimeters on either side). As such, it is common for those mirrors to collide with posts, pylons, walls, other vehicles, and/or other structures, particularly in parking lots, narrow driveways, and other tight spaces. For example, side-view mirrors are often damaged while entering or exiting parking spaces and garages.

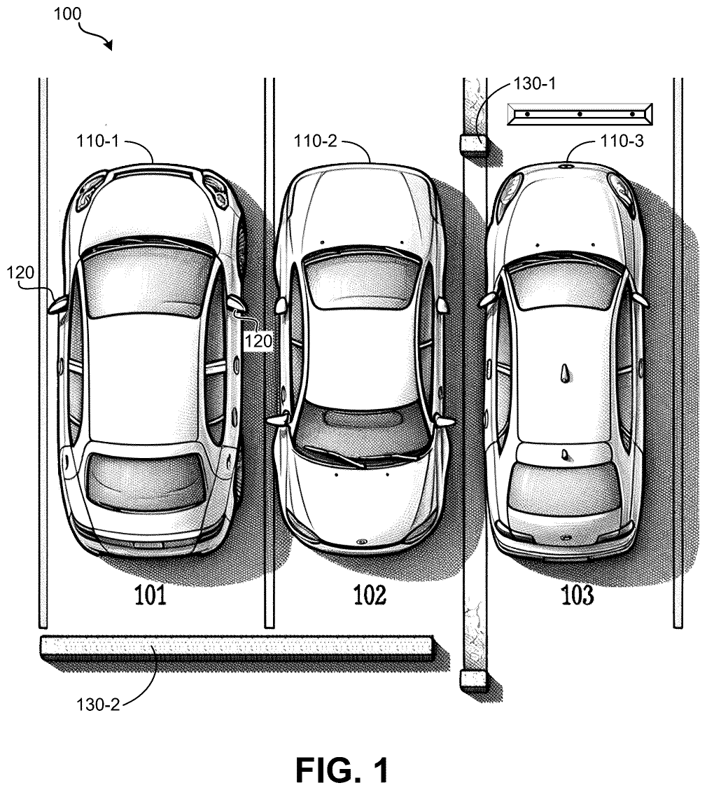

FIG. 1 shows an illustrative parking environment 100 including multiple potential collision hazards that could result in damage to a side-view mirror of a vehicle. In the parking environment 100, there are three parking spaces, labeled ‘101’, ‘102’, and ‘103’. A vehicle 110 is parked in each space. As is typical in many such environments, the vehicles 110 are not all parked perfectly in the centers of their respective spaces, and the spaces are surrounded by various types of structural obstacles 130, such as concrete pylons, walls, etc. The vehicles 110 are all shown with side-view mirrors 120 protruding from their respective driver and passenger sides, which adds to the effective width of each vehicle 110. It can be difficult for a driver of any of the three vehicles 110 to enter or exit their parking space without causing damage to or from their side-view mirrors 120. For example, for vehicle 110-2 to back out of space 102 without any collisions, the driver will have to avoid hitting vehicle 110-1, vehicle 110-3, pylon 130-1, etc. It can be seen that even the relatively small added width of the three vehicles 110 due to their side-view mirrors 120 makes it even more difficult to navigate the environment 100 without a collision.

Embodiments described herein include novel techniques for automatically and actively protecting the side-view mirror(s) 120 of a vehicle from causing and/or receiving damage. Data from mirror collision anticipation sensors (MCASs) are used to detect when a mirror collision event is imminent. Such detecting can automatically trigger a motorized coupling between the side-view mirror 120 and the vehicle body to reposition (e.g., fold in) the mirror to avoid the mirror collision event. Some embodiments include additional features, such as use of one or more prediction models for the detection, triggering of one or more indicators in addition to triggering the motorized response, triggering of one or more indicators instead of triggering the motorized response when the motorized response is anticipated to be ineffective, etc.

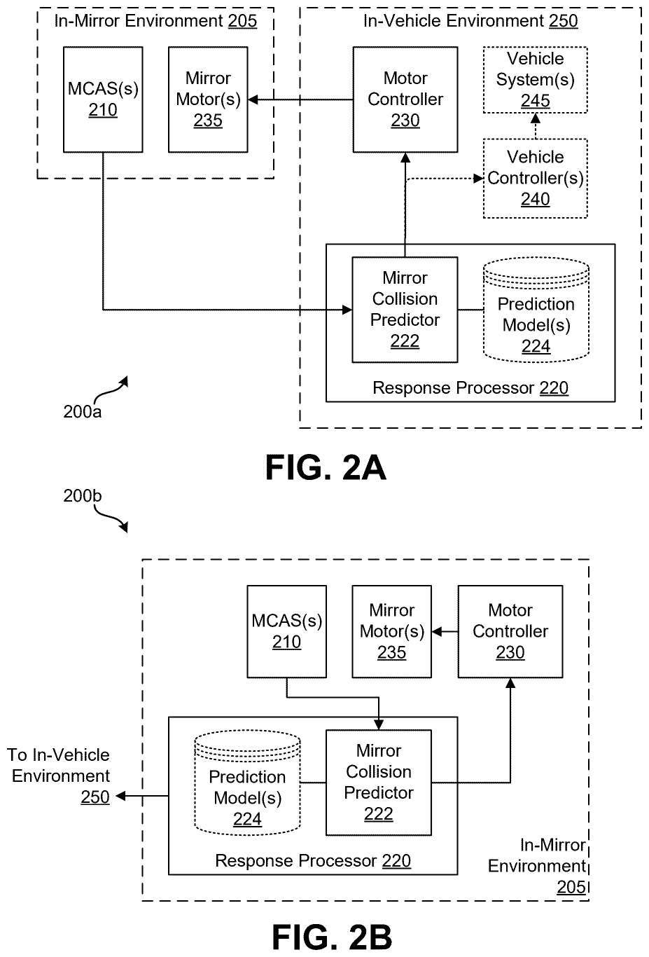

FIGS. 2A and 2B show block diagrams of illustrative mirror collision avoidance systems 200, according to various embodiments described herein. Both mirror collision avoidance systems 200 include one or more mirror collision anticipation sensors (MCASs) 210, a response processor 220, a motor controller 230, and one or more mirror motors 235. The mirror collision avoidance systems 200 are designed to be incorporated into any vehicle having at least one side-view mirror, such as any of the vehicles 110 of FIG. 1. In general, the side-view mirror(s) are mounted to the main-body of the vehicle. The main body (i.e., what the side-view mirror(s) are mounted to) defines an in-vehicle environment 250. The side-view mirrors can define an in-mirror environment 205, or each side-view mirror can define its own respective instance or portion of an in-mirror environment 205.

As illustrated, the mirror collision avoidance systems 200 can be implemented with different portions of the mirror collision avoidance system 200 distributed in different ways between the in-mirror environment(s) 205 and the in-vehicle environment 250. FIGS. 2A and 2B show two of several such implementations. In the mirror collision avoidance system 200a of FIG. 2A, the in-mirror environment(s) 205 only include the MCAS(s) 210 and the mirror motor(s) 235, and the rest of the components (e.g., at least the response processor 220 and motor controller 230) are disposed in the in-vehicle environment 250. In the mirror collision avoidance system 200b of FIG. 2B, the in-mirror environment(s) 205 includes all the components, and the in-mirror environment 205 can be physically and electrically coupled with the in-vehicle environment 250. For example, the mirror collision avoidance system 200b of FIG. 2B can be implemented as a fully integrated side-view mirror assembly that is mounted to a vehicle and coupled with the in-vehicle environment 250 via a wiring harness (e.g., between the response processor 220 and a body control module, door control module, or other microprocessor-based subsystem of the vehicle). Some embodiments implement such a fully integrated side-view mirror assembly for installation during initial factory assembly of the vehicle. Other embodiments implement such a fully integrated side-view mirror assembly as a repair or retrofit kit. Other embodiments implement such a fully integrated side-view mirror assembly as an upgrade kit.

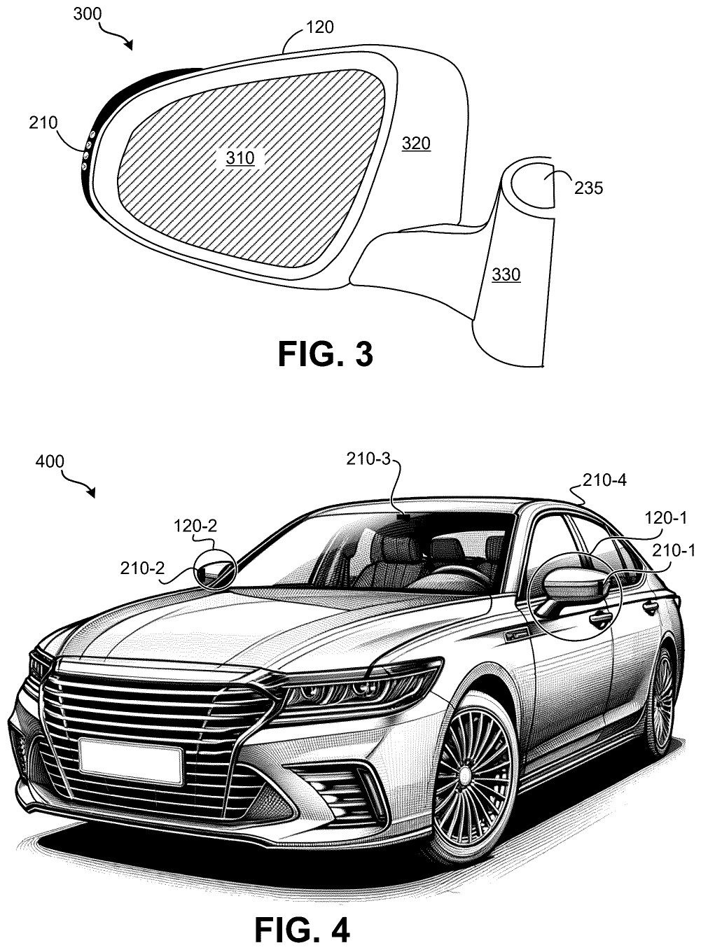

Turning briefly to FIG. 3, an example of a side-view mirror 300 is shown. The side-view mirror 300 can include many different types of components, such as mirror glass 310, a mirror housing 320, and a mounting assembly 330 for physically coupling the side-view mirror 300 with a vehicle. Though not explicitly shown, the mirror housing 320 can house many types of components, such as manual and/or power-operated adjustment mechanisms; motors, gears, cams, etc. (e.g., for power mirrors); heating elements for heated and/or defogging mirrors; indicators (e.g., a turn signal indicator, a puddle light, a blind spot warning light, etc.); and a wiring harness for electrically coupling electrical systems of the side-view mirror 300 (including those of the in-mirror environment 205) with other electrical systems of the vehicle (including those of the in-vehicle environment 250). Embodiments of the mounting assembly can include any suitable mounting components, such as one or more mounting brackets, screws, clips, weather seals, covers, caps, etc.

As described herein, the physical and electrical environment of the side-view mirror 300 are considered as the in-mirror environment 205, and other physical and electrical environments of the vehicle are considered as the in-vehicle environment 250. For example, in the illustrated side-view mirror 300 of FIG. 3, one or more of the MCASs 210 is integrated with the mirror housing 320, and one or more of the mirror motors 235 is integrated with the mounting assembly 330.

Returning to FIGS. 2A and 2B, in general, the MCAS(s) 210 generate one or more sensor signals based on detecting a proximate environment of one or more vehicle side-view mirrors. The response processor 220 includes a sensor input to electrically couple with the MCAS(s) 210 to receive the sensor signals. The response processor 220 also includes a mirror collision predictor 222 to compute a present likelihood of an imminent collision event based on monitoring the sensor signals. The response processor 220 (e.g., the mirror collision predictor 222) can generate a trigger signal responsive to detecting that the present likelihood exceeds a predetermined trigger threshold. The response processor 220 also includes a motor control output to electrically couple with the motor controller motor controller 230 to trigger the motor controller 230 to execute an automated mirror evasion maneuver responsive to the trigger signal. The trigger signal can direct the motor controller 230 to electromechanically reposition one or both vehicle side-view mirrors relative to a vehicle main body in any suitable manner to avoid the imminent collision event. For example, the trigger signal directs the motor controller 230 automatically to fold in one or both side-view mirrors.

Embodiments of the MCAS(s) 210 can include any suitable sensor technologies for detecting the proximate environment of one or more vehicle side-view mirrors in a manner that provides sensor information suitable for use in computing a present likelihood of an imminent collision. In some implementations, the MCAS(s) 210 include one or more RADAR (Radio Detection and Ranging) sensors, which detect distances, speeds, and angles of proximate objects based on radio waves. Such sensors are beneficial in such contexts as they are generally effective in most weather conditions, such that they are usable for collision anticipation even when there is otherwise poor visibility due to fog, snow, rain, etc. In some implementations, the MCAS(s) 210 include one or more LIDAR (Light Detection and Ranging) sensors. LIDAR is based on emitting pulsed laser light and measuring reflection times to create high-resolution, 3D representations of the proximate environment, which can provide precise object detection and distance measurements. In some implementations, the MCAS(s) 210 include one or more cameras to acquire video data of the proximate environment. Combining the video data with advanced computer vision can produce accurate information about surrounding obstacles, or other sources of imminent collision. In some implementations, the MCAS(s) 210 include one or more ultrasonic sensors, which can detect proximity of potential sources of imminent collision based on sound waves. In some embodiments, the MCAS(s) 210 include multiple sensors of multiple sensor technologies to balance their respective features and limitations.

The MCAS(s) 210 generate sensor signals indicating information about the proximate environment. As described above, depending on the types of sensors included in the MCAS(s) 210 the information can indicate a distance of a sensor from an obstacle, a precise representation of the geometry of a proximate obstacle, a rate of change in the distance of the obstacle (i.e., the obstacle's speed toward or away from a side-view mirror), etc. The MCAS(s) 210 can be located in one or more places on a vehicle and can be pointed in one or more directions relative to the vehicle, which can also impact the types of information that can be acquired by the MCAS(s) 210 about the proximate environment of one or both side-view mirrors. Turning briefly to FIG. 4, an example of a vehicle 400 is shown with side view mirrors 120 and several MCASs 210. As illustrated, MCAS(s) 210-1 are integrated with the driver-side side-view mirror 210-1, MCAS(s) 210-2 are integrated with the passenger-side side-view mirror 210-2, MCAS(s) 210-3 are integrated with a so-called “dash cam” (e.g., mounted on the rear-view mirror or near the top of the front windshield), MCAS(s) 210-4 are positioned in the rear of the vehicle (e.g., integrated with a back-up camera), etc. For example, MCAS(s) 210-1 and MCAS(s) 210-2 can use ultrasonic, RADAR, or LIDAR types of sensors to support mostly distance-based collision anticipation, and MCAS(s) 210-3 and MCAS(s) 210-4 can include camera-based systems to support more advanced collision anticipation (e.g., based on using real-time imagery to determine whether a width of an opening is sufficient to accommodate the width of the vehicle including the side-view mirrors). Different implementations of a vehicle can include one or more of these types and/or locations of MCAS(s) 210, and/or additional or alternative types and/or locations of MCAS(s) 210.

The sensor signals from the MCAS(s) 210 are received by the response processor 220. Embodiments of the response processor 220 can be implemented using any suitable type of computational environment, such as any suitable type of processor. Where the processor is a general-purpose processor, the processor is integrated with, or in communication with, a non-transitory memory having instructions stored thereon that reconfigure the general-purpose processor into a special purpose processing environment. Some embodiments are implemented using one or more microcontrollers (MCUs), which can integrate a core processor, a non-transitory processor-readable memory, and input/output ports. Some further integrate input/output peripherals and/or other components. Some embodiments are implemented using one or more application-specific integrated circuits (ASICs), field-programmable gate arrays (FPGAs), digital signal processors (DSPs), graphics processing units (GPUs), and/or the like, which have been custom-designed to perform the tasks described herein. Some embodiments are implemented using one or more system-on-a-chip (SoC) processors, which can combine multiple components, such as MCUs, DSPs, GPUs, non-transitory memories, etc. into a single chip.

As described above, the response processor 220 includes a mirror collision predictor 222 that monitors the sensor signals from the MCAS(s) 210 to anticipate an imminent collision event. Such monitoring can be continuous, periodic, or in any suitable manner. In some embodiments, the response processor 220 computes the present likelihood of an imminent collision event based on monitoring the sensor signals and directly interpreting the information conveyed by those signal based on one or more rule-based algorithms. In some embodiments having RADAR, LIDAR, and/or ultrasonic sensors in the MCAS(s) 210, the response processor 220 can compute precise distance measurements based on time delays between sending and receiving radio, light, and/or sound waves. In such embodiments, response processor 220 can monitor changes in these distance measurements to detect when either the distance between a side-view mirror and a proximate object falls below a predetermined threshold distance and/or whether a closing speed between the side-view mirror and a proximate object exceeds a predetermined threshold closing speed. In some embodiments having camera-based sensors in the MCAS(s) 210, the response processor 220 can receive real-time images of the vehicle's surroundings and use relatively simple image processing algorithms to detect, for example, changes in an imaged proximate object's size over time, which can indicate whether the proximate object appears to be getting closer or farther from the side-view mirror. In some embodiments, multiple types of sensor signals from multiple sensor technologies of the MCAS(s) 210 are used by the response processor 220 in an integrated manner, such as by using sensor fusion technologies and algorithms.

In some embodiments, the response processor 220 computes the present likelihood of an imminent collision event based on monitoring the sensor signals and applying one or more prediction models 224, which can be stored in non-transitory storage integrated with, or in communication with the mirror collision predictor 222. The prediction model(s) 224 are based on one or more machine learning architectures, which are trained to detect when a collision event with one or both side-view mirrors is imminent. Some embodiments of the prediction model(s) 224 include one or more convolutional neural networks (CNNs). In some such embodiments, the CNNs are trained to analyze visual data from cameras, and/or other MCAS(s) 210, to identify proximate objects and to determine whether the proximate objects pose a collision risk for one or both side-view mirrors. For example, the CNNs can classify the objects, determine their relative positions, determine their relative speeds and directions, etc. Some embodiments of the prediction model(s) 224 include one or more recurrent neural networks (RNNs), such as long short-term memory (LSTM) networks. Such networks can be trained to use sensor signals with time-series data, such as signals from RADAR, LIDAR, ultrasonic, and/or other sensors, to estimate future positions of proximate objects based on current positions and trajectories, or the like. As noted above, data fusion technologies and algorithms can be used to exploit aggregated sensor signals from different sensor technologies. combine data from different sensors (sensor fusion) to get a comprehensive understanding of the environment using techniques, such as Kalman filters, deep learning, etc.

The prediction model(s) 224 can be trained in any suitable manner. For example, embodiments can use one or more of supervised learning (e.g., in which prediction model(s) 224 are pre-trained based on labeled training data), unsupervised learning (e.g., in which prediction model(s) 224 are trained to discover patterns without relying on pre-labeled training data), semi-supervised training (e.g., in which prediction model(s) 224 are pre-trained based on labeled and unlabeled training data, or on unlabeled data with subsequent manual correction), and/or transfer learning (e.g., in which prediction model(s) 224 are trained to distill knowledge from a highly complex teacher model), etc. The training data can be based on simulated environments, real-world data collected from vehicles, and/or any other suitable data source. Some embodiments of the prediction model(s) 224 are designed to use reinforcement learning from environmental feedback, such as to continually improve its adaptability and real-time decision-making capability.

When the response processor 220 detects an imminent collision event, embodiments output a trigger signal. Outputting the trigger signal can involve generating and outputting signal via a signal output line, toggling the value of trigger bit, changing a voltage level, by issuing an interrupt, or any other type of signaling. As illustrated, the trigger signal can be used to cause the motor controller 230 to direct the mirror motor(s) 235 to execute an automated evasion routine. In some embodiments, the automated evasion routine involves the mirror motor(s) 235 folding in one or both mirrors (i.e., so that they lay flatter against the sides of the vehicle). Other routines can include more intricate electromechanical movement options, such as using the mirror motor(s) 235 to move one or both mirrors in an upward direction, a downward direct, a rotational direction, etc.

In some embodiments, the trigger signal can be used by one or more other vehicle controller(s) 240 automatically to direct operation of one or more vehicle system(s) 245. In some such embodiments, the vehicle controller(s) 240 are used to direct operation of an indicator system (i.e., the indicator system is included in the one or more vehicle system(s) 245). For example, the trigger signal can cause the indicator system to illuminate one or more visual indicators (e.g., warning lights on the side-view mirrors, on the dashboard, on an in-vehicle display, etc.), to sound one or more alarm tones or sounds, to generate haptic feedback (e.g., by vibrating the steering wheel), etc. In some such embodiments, the vehicle controller(s) 240 are used to direct operation of a braking system and/or a steering system (i.e., the braking system and/or steering system is included in the one or more vehicle system(s) 245). For example, the trigger signal can cause the vehicle automatically to brake and/or take over steering prior to either or both side-view mirrors colliding with one or more objects.

Some embodiments of the response processor 220 can generate different types of trigger signals (e.g., toggle different bits, send different types of information, different priority levels, etc.) to trigger different types of reactions. For example, the trigger signal may be configured only to trigger automatic braking of a braking system when the vehicle is traveling at a slow speed. In some embodiments, the response processor 220 continues to monitor some or all of the MCAS(s) 210 (e.g., and/or different MCAS(s) 210) subsequent to triggering the automated evasion routine. For example, after folding in the side-view mirrors, the response processor 220 can continue to monitor the MCAS(s) 210 to determine whether folding in the mirrors is likely to avoid the detected imminent collision event; if not, the trigger signal can be updated (e.g., the priority level can be increased) to trigger one or more other responses, such as triggering a warning, automatically braking, etc.

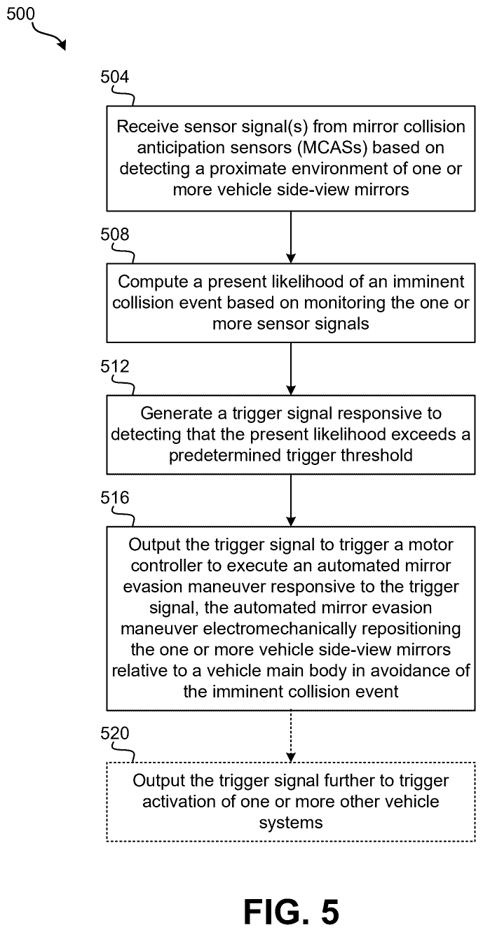

FIG. 5 shows a flow diagram of a method 500 for mirror collision avoidance in a vehicle. Embodiments of the method begin at stage 504 by receiving one or more sensor signals from one or more mirror collision anticipation sensors (MCASs). As described herein, the MCASs generate the one or more sensor signals based on detecting a proximate environment of one or more vehicle side-view mirrors. At stage 508, embodiments can compute a present likelihood of an imminent collision event based on monitoring the one or more sensor signals. In some embodiments, the computing at stage 508 includes applying one or more prediction models to the one or more sensor signals. As described herein, each of the one or more prediction models includes a pre-trained machine learning network (e.g., a CNN, RNN, LSTM, etc.).

At stage 512, embodiments can generate a trigger signal responsive to detecting that the present likelihood exceeds a predetermined trigger threshold. In some embodiments, the computing at stage 508 includes estimating a distance of one or more objects proximate to the one or more vehicle side-view mirrors based on monitoring the one or more sensor signals; and the generating at stage 512 is responsive to detecting that the distance is less than a predetermined threshold distance. In some embodiments, the computing at stage 508 includes estimating a closing speed between one or more objects and the one or more vehicle side-view mirrors based on monitoring the one or more sensor signals; and the generating at stage 512 is responsive to detecting that the closing speed is greater than a predetermined threshold closing speed. In some embodiments, the computing at stage 508 includes estimating a passage width of a passage which the vehicle is approaching to enter based on monitoring the one or more sensor signals; and the generating at stage 512 is responsive to detecting that the passage width is narrower than a predetermined safe entry width that accounts for a largest width of the vehicle including the one or more vehicle side-view mirrors.

At stage 516, embodiments can output the trigger signal to trigger a motor controller to execute an automated mirror evasion maneuver responsive to the trigger signal. The automated mirror evasion maneuver electromechanically repositioning (e.g., folding in) the one or more vehicle side-view mirrors relative to a vehicle main body in avoidance of the imminent collision event. In some embodiments, the method 500 further includes outputting the trigger signal further to trigger activation of one or more other vehicle systems at stage 520. For example, as described herein, the outputting at stage 520 can cause activation of an indicator system, a braking system, a steering system, etc.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of example configurations (including implementations). However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process which is depicted as a flow diagram or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

Having described several example configurations, various modifications, alternative constructions, and equivalents may be used without departing from the spirit of the disclosure. Components of a larger system, wherein other rules may take precedence over or otherwise modify the application of the invention. Also, a number of steps may be undertaken before, during, or after the above elements are considered.

What is claimed is:

1. A mirror collision avoidance system for a vehicle, the system comprising:
one or more mirror collision anticipation sensors (MCASs) to generate one or more sensor signals based on detecting a proximate environment of one or more vehicle side-view mirrors;
a motor controller to electromechanically reposition the one or more vehicle side-view mirrors relative to a vehicle main body;
a response processor comprising:
a sensor input to electrically couple with the one or more MCASs to receive the one or more sensor signals;
a mirror collision predictor to compute a present likelihood of an imminent collision event based on monitoring the one or more sensor signals, and to generate a trigger signal responsive to detecting that the present likelihood exceeds a predetermined trigger threshold; and
a motor control output to electrically couple with the motor controller to trigger the motor controller to execute an automated mirror evasion maneuver responsive to the trigger signal.

2. The system of claim 1, wherein:
the response processor further comprises a non-transitory processor-readable memory having one or more prediction models stored thereon, each of the one or more prediction models comprising a pre-trained machine learning network; and
the mirror collision predictor is to compute the present likelihood of the imminent collision event by applying the one or more prediction models to the one or more sensor signals.

3. The system of claim 2, wherein the pre-trained machine learning network of at least one of the one or more prediction models is a convolutional neural network.

4. The system of claim 1, wherein the mirror collision predictor is to:
compute the present likelihood of the imminent collision event based on estimating a distance of one or more objects proximate to the one or more vehicle side-view mirrors based on monitoring the one or more sensor signals; and
generate the trigger signal responsive to detecting that the distance is less than a predetermined threshold distance from the one or more vehicle side-view mirrors.

5. The system of claim 1, wherein the mirror collision predictor is to:
compute the present likelihood of the imminent collision event based on estimating a closing speed between one or more objects and the one or more vehicle side-view mirrors based on monitoring the one or more sensor signals; and
generate the trigger signal responsive to detecting that the closing speed is greater than a predetermined threshold closing speed.

6. The system of claim 1, wherein the mirror collision predictor is to:
compute the present likelihood of the imminent collision event based on estimating a passage width of a passage which the vehicle is approaching to enter based on monitoring the one or more sensor signals; and
generate the trigger signal responsive to detecting that the passage width is narrower than a predetermined safe entry width that accounts for a largest width of the vehicle including the one or more vehicle side-view mirrors.

7. The system of claim 1, wherein the one or more MCASs comprise at least one of an ultrasonic sensor, a RADAR sensor, or a LIDAR sensor, such that the one or more sensor signals comprise time-series distance data.

8. The system of claim 1, wherein the one or more MCASs comprise a camera, such that the one or more sensor signals comprise real-time image data.

9. The mirror collision avoidance system of claim 1, wherein:
the motor controller and at least one of the one or more MCASs are integrated within a side-view mirror assembly having a mirror glass and a mirror housing.

10. The mirror collision avoidance system of claim 2, wherein:
the response processor is further integrated within the side-view mirror assembly.

11. A side-view mirror assembly comprising:
a mirror housing;
a mirror glass installed in the mirror housing;
a mounting assembly to physically couple the mirror housing with a vehicle main body, the mounting assembly having a motor controller to integrated therein to electromechanically reposition the one or more vehicle side-view mirrors relative to the vehicle main body; and
a response processor disposed in the mirror housing and comprising:
a sensor input to electrically couple with one or more mirror collision anticipation sensors (MCASs) to receive one or more sensor signals generated by the one or more MCASs based on detecting a proximate environment of the mirror housing;
a mirror collision predictor to compute a present likelihood of an imminent collision event based on monitoring the one or more sensor signals, and to generate a trigger signal responsive to detecting that the present likelihood exceeds a predetermined trigger threshold; and
a motor control output to electrically couple with the motor controller to trigger the motor controller to execute an automated mirror evasion maneuver responsive to the trigger signal.

12. The side-view mirror assembly of claim 11, further comprising:
at least one of the MCASs integrated with the mirror housing.

13. The side-view mirror assembly of claim 11, wherein:
the response processor further comprises a non-transitory processor-readable memory having one or more prediction models stored thereon, each of the one or more prediction models comprising a pre-trained machine learning network; and
the mirror collision predictor is to compute the present likelihood of the imminent collision event by applying the one or more prediction models to the one or more sensor signals.

14. The side-view mirror assembly of claim 11, wherein the mirror collision predictor is to:
compute the present likelihood of the imminent collision event based on estimating, based on monitoring the one or more sensor signals, a distance of one or more objects proximate to the mirror housing, and/or a closing speed between one or more objects and the mirror housing; and
generate the trigger signal responsive to detecting that the distance is less than a predetermined threshold distance and/or that the closing speed is greater than a predetermined threshold closing speed.

15. A method for mirror collision avoidance in a vehicle, the method comprising:
receiving one or more sensor signals from one or more mirror collision anticipation sensors (MCASs), the MCASs to generate the one or more sensor signals based on detecting a proximate environment of one or more vehicle side-view mirrors;
computing a present likelihood of an imminent collision event based on monitoring the one or more sensor signals;
generating a trigger signal responsive to detecting that the present likelihood exceeds a predetermined trigger threshold; and
outputting the trigger signal to trigger a motor controller to execute an automated mirror evasion maneuver responsive to the trigger signal, the automated mirror evasion maneuver electromechanically repositioning the one or more vehicle side-view mirrors relative to a vehicle main body in avoidance of the imminent collision event.

16. The method of claim 15, wherein:
the computing comprises applying one or more prediction models to the one or more sensor signals, each of the one or more prediction models comprising a pre-trained machine learning network.

17. The method of claim 15, wherein:
the computing comprises estimating a distance of one or more objects proximate to the one or more vehicle side-view mirrors based on monitoring the one or more sensor signals;
and the generating the trigger signal is responsive to detecting that the distance is less than a predetermined threshold distance.

18. The method of claim 15, wherein:
the computing comprises estimating a closing speed between one or more objects and the one or more vehicle side-view mirrors based on monitoring the one or more sensor signals; and
the generating the trigger signal is responsive to detecting that the closing speed is greater than a predetermined threshold closing speed.

19. The method of claim 15, wherein:
the computing comprises estimating a passage width of a passage which the vehicle is approaching to enter based on monitoring the one or more sensor signals; and
the generating the trigger signal is responsive to detecting that the passage width is narrower than a predetermined safe entry width that accounts for a largest width of the vehicle including the one or more vehicle side-view mirrors.

20. The method of claim 15, further comprising:
outputting the trigger signal further to trigger activation of one or more of: an indicator system, a braking system, or a steering system.
